(19) United States
(12) Patent Application Publication
(10) Pub. No.: US 2017/0242266 A1
(43) Pub. Date: Aug. 24, 2017

(54) ILLUMINATION DEVICE AND PROJECTOR

(71) Applicant: SEIKO EPSON CORPORATION, Tokyo (JP)

(72) Inventor: Makoto OTANI, Matsumoto-shi (JP)

(73) Assignee: SEIKO EPSON CORPORATION, Tokyo (JP)

(21) Appl. No.: 15/431,223

(22) Filed: Feb. 13, 2017

(30) Foreign Application Priority Data
Feb. 19, 2016 (JP) 2016-030219

(51) Int. Cl. G02B 27/48; G03B 21/00; G02B 19/00; G03B 21/20; G02B 27/30; G02B 3/00

(52) U.S. Cl. CPC G02B 27/48; G02B 27/30; G02B 3/0056; G02B 19/0014; G03B 21/208; G03B 21/005

(57) ABSTRACT

The disclosure relates to an illumination device including a light source device that emits a bundle of rays including first and second light beams, a collimating optical system, a diffusing element, a first collecting optical system, a first lens array, a second lens array, and a second condensing optical system in this order. The first light beam and the second light beam enter different regions on the diffusing element. A principal ray of the first light beam and a principal ray of the second light beam travel so as to come close to each other toward the first lens array. The diffusing element is provided in the vicinity of a focal position of the first collecting optical system.

### BACKGROUND

1. Technical Field

The present invention relates to an illumination device and a projector.

2. Related Art

In recent years, a laser light source is attracting attention as a light source for a projector. However, since laser light is coherent light, a speckled pattern caused by interference, called speckle, is displayed on a screen and causes a reduction in display quality. Therefore, in a display device disclosed in JP-A-2012-226292, the speckle is reduced by moving a prism array on which the laser light is incident.

In the display device, however, a drive mechanism for moving the prism array is needed, and thus the structure is complicated.

Therefore, it is conceivable to inexpensively reduce the speckle by using, as a diffusing member, a light scatter disclosed in JP-A-7-198949, which is obtained by dispersing particles with different refractive indices in a matrix made of a transparent inorganic material.

A sufficiently large diffusion angle is required to reduce the speckle by focusing light onto one point of the diffusing element and diffusing the light at the point. However, backscattering occurs at the diffusing member having a large diffusion angle, and thus light use efficiency is reduced.

### SUMMARY

An advantage of some aspects of the invention is to provide an illumination device and a projector each of which has reduced speckle and high light-use efficiency.

A first aspect of the invention provides an illumination device including: alight source device that emits a bundle of rays including a first light beam and a second light beam; a collimating optical system on which the bundle of rays is incident; a diffusing element on which the bundle of rays transmitted through the collimating optical system is incident; a first collecting optical system on which the bundle of rays diffused by the diffusing element is incident; a first lens array on which the bundle of rays transmitted through the first collecting optical system is incident; a second lens array provided at the rear stage of the first lens array; and a second condensing optical system provided at the rear stage of the second lens array, wherein the first light beam and the second light beam are incident in regions different from each other on the diffusing element, a principal ray of the first light beam and a principal ray of the second light beam travel so as to come close to each other toward the first lens array, and the diffusing element is provided in the vicinity of a focal position of the first collecting optical system.

According to the illumination device according to the first aspect, the first light beam and the second light beam enter different regions on the diffusing element. Therefore, a spot size that is formed on the diffusing element is larger than a spot size that is formed on the diffusing element when the first light beam and the second light beam enter the same region on the diffusing element. Therefore, it is possible to reduce the diffusion angle while ensuring a speckle-reducing effect.

Hence, backscattering at the diffusing element can be reduced. Moreover, since a light component having a large incident angle with respect to the first collecting optical system is reduced, reflection on the surface of a lens constituting the first collecting optical system is reduced.

Hence, the loss due to the backscattering at the diffusing element and the reflection on the lens surface are reduced, so that high light-use efficiency is obtained.

In the first aspect, it is preferable that the principal ray of the first light beam and the principal ray of the second light beam are incident in the state of being parallel to each other on the diffusing element.

According to this configuration, a spot size that is formed on the diffusing element by excitation light can be increased.

In the first aspect, it is preferable that the first collecting optical system includes, in order from the diffusing element side, a first lens group having a positive power, a second lens group having a negative power, and a third lens group having a positive power.

According to this configuration, an optical length in the first collecting optical system can be shortened.

In the first aspect, it is preferable that the principal ray of the first light beam and the principal ray of the second light beam are incident so as to be concentrated on the diffusing element.

According to this configuration, the number of lenses constituting the first collecting optical system can be reduced.

A second aspect of the invention provides a projector including: the illumination device according to the first aspect; a light modulator that modulates, in response to image information, light from the illumination device to thereby form image light; and a projection optical system that projects the image light.

Since the projector according to the second aspect includes the illumination device according to the first aspect, the projector has high light-use efficiency and can display a bright image.

### BRIEF DESCRIPTION OF THE DRAWINGS

The invention will be described with reference to the accompanying drawings, wherein like numbers reference like elements.

FIG. 1 is a top view showing an optical system of a projector according to a first embodiment.

FIG. 2 is a ray diagram of blue light.

FIG. 3 is a diagram showing only principal rays of rays with respect to FIG. 2.

FIG. 4 is a diagram showing a configuration of a main portion of a diffusing element.

FIG. 5 is a top view showing an optical system of a projector according to a second embodiment.

FIG. 6 is a ray diagram in a main portion of a first illumination device.

FIG. 7 is a diagram showing only principal rays of rays with respect to FIG. 6.

FIG. 8 is a ray diagram of blue light according to a modified example of the second embodiment.

FIG. 9 is an enlarged view showing a main portion of blue light emitted from the diffusing element.

FIG. 10 is a diagram showing only principal rays of rays with respect to FIG. 8.

FIG. 11 is a top view showing an optical system of a projector according to a third embodiment.

FIG. 12 is a ray diagram in a main portion of a blue illumination device.

FIG. 13 is a diagram showing only principal rays of rays with respect to FIG. 12.

FIG. 14 is a ray diagram of blue light according to a modified example of the third embodiment.

FIG. 15 is an enlarged view showing a main portion of blue light emitted from the diffusing element.

FIG. 16 is a top view showing an optical system of a projector according to a fourth embodiment.

### DESCRIPTION OF EXEMPLARY EMBODIMENTS

Hereinafter, embodiments of the invention will be described in detail with reference to the drawings.

In the drawings used in the following description, a characteristic portion may be shown in an enlarged manner, for convenience sake, to facilitate understanding thereof, and thus the dimension ratio and the like of each component are not always the same as actual ones.

### First Embodiment

An example of a projector according to a first embodiment will be described. The projector of the embodiment is a projection-type image display device that displays a color video on a screen (projected surface) SCR. The projector includes three liquid crystal light modulators corresponding to respective colored lights: red light, green light, and blue light. The projector includes, as a light source of an illumination device, a semiconductor laser from which high-luminance, high-output light is obtained.

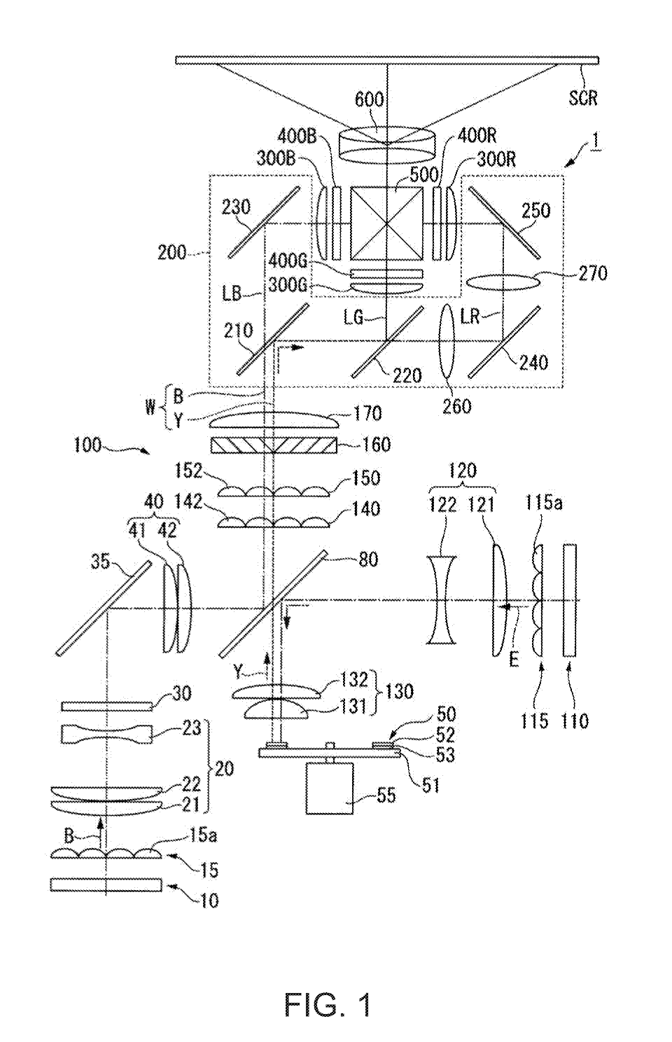

FIG. 1 is a top view showing an optical system of the projector according to the embodiment.

As shown in FIG. 1, the projector 1 includes an illumination device 100, a color separation and light guide optical system 200, liquid crystal light modulators 400R, 400G, and 400B, a cross dichroic prism 500, and a projection optical system 600.

In the embodiment, the illumination device 100 emits white light W toward the color separation and light guide optical system 200.

The color separation and light guide optical system 200 includes dichroic mirrors 210 and 220, reflection mirrors 230, 240, and 250, and relay lenses 260 and 270. The color separation and light guide optical system 200 separates the white light W from the illumination device 100 into red light LR, green light LG, and blue light LB, and guides the red light LR, the green light LG, and the blue light LB to the respectively corresponding liquid crystal light modulators 400R, 400G, and 400B.

Field lenses 300R, 300G, and 300B are disposed between the color separation and light guide optical system 200 and the liquid crystal light modulators 400R, 400G, and 400B.

The dichroic mirror 210 is a dichroic mirror that transmits a blue light component and reflects a green light component and a red light component.

The dichroic mirror 220 is a dichroic mirror that reflects the green light component and transmits the red light component.

The reflection mirror 230 is a reflection mirror that reflects the blue light component.

The reflection mirrors 240 and 250 are reflection mirrors that reflect the red light component.

The blue light LB transmitted through the dichroic mirror 210 is reflected by the reflection mirror 230, passes through the field lens 300B, and is incident on the image forming region of the liquid crystal light modulator 400B for blue light.

The green light LG reflected by the dichroic mirror 210 is further reflected by the dichroic mirror 220, passes through the field lens 300G, and is incident on the image forming region of the liquid crystal light modulator 400G for green light.

The red light LR transmitted through the dichroic mirror 220 is incident on the image forming region of the liquid crystal light modulator 400R for red light through the relay lens 260, the reflection mirror 240, the relay lens 270, the reflection mirror 250, and the field lens 300R.

The liquid crystal light modulators 400R, 400G, and 400B modulate, in response to image information, the colored lights incident thereon, and form color images corresponding to the respective colored lights. Although not shown in the drawing, light incident-side polarizers are disposed between the field lenses 300R, 300G, and 300B and the liquid crystal light modulators 400R, 400G, and 400B while light exiting-side polarizers are disposed between the liquid crystal light modulators 400R, 400G, and 400B and the cross dichroic prism 500.

The cross dichroic prism 500 is an optical element that combines the image lights emitted from the liquid crystal light modulators 400R, 400G, and 400B to form a color image.

The cross dichroic prism 500 has a substantially square shape in a plan view in which four right-angle prisms are bonded together, and dielectric multi layer films are formed at substantially X-shaped interfaces between the right-angle prisms bonded together.

The color image emitted from the cross dichroic prism 500 is enlarged and projected by the projection optical system 600 to form an image on the screen SCR.

The illumination device 100 includes a first light source device 10, a first collimating optical system 15, a first afocal optical system 20, a diffusing element 30, a reflection mirror 35, a pickup optical system 40, a dichroic mirror 80, a second light source device 110, a second collimating optical system 115, a second afocal optical system 120, a pickup optical system 130, a rotating fluorescent plate 50, a first lens array 140, a second lens array 150, a polarization conversion element 160, and a superimposing lens 170. In the embodiment, the first collimating optical system 15 corresponds to “collimating optical system” in the appended claims.

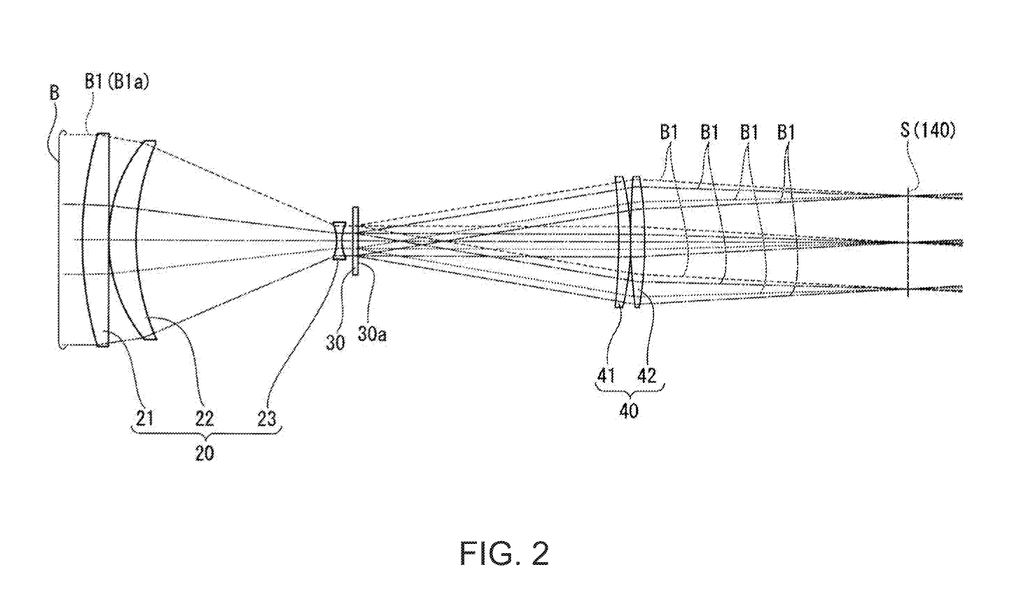

The first light source device 10 includes a semiconductor laser that emits blue light beam (emission intensity peak: approximately 445 nm) including laser light. The first light source device 10 includes a plurality of the semiconductor lasers. The first collimating optical system 15 includes a plurality of collimating lenses 15a provided corresponding to the semiconductor lasers. As shown in FIG. 2, blue light B emitted from the first light source device 10 includes a bundle of rays including a plurality of rays B1 emitted from the semiconductor lasers. The ray B1 emitted from the semiconductor laser is collimated by the corresponding collimating lens 15a. For the first light source device 10, a semiconductor laser that emits blue light at a wavelength of other than 445 nm (e.g., 460 nm) can also be used.

The first afocal optical system 20 includes a first lens 21, a second lens 22, and a third lens 23. Each of the first lens 21 and the second lens 22 is formed of a plano-convex lens including a curved surface on the light incident-surface side. The third lens 23 is formed of a double-concave lens. The first afocal optical system 20 adjusts the luminous flux diameter of the blue light B.

The diffusing element 30 is formed of, for example, frosted glass, a holographic diffuser, a microlens array, or the like. The diffusing element 30 of the embodiment is formed of, for example, a microlens array. A detailed configuration of the diffusing element 30 will be described later.

The pickup optical system 40 includes a first pickup lens 41 and a second pickup lens 42. Each of the first pickup lens 41 and the second pickup lens 42 (hereinafter, these may be collectively referred to as “lenses 41 and 42”) is formed of a plano-convex lens including a spherical surface on the light exiting-surface side. In the embodiment, the pickup optical system 40 corresponds to “first collecting optical system” in the appended claims.

The second light source device 110 is formed of a plurality of semiconductor lasers and emits, as excitation light, blue light E (emission intensity peak: approximately 445 nm) including laser light.

The second afocal optical system 120 includes a first lens 121 and a second lens 122. The first lens 121 is formed of a plano-convex lens including a curved surface on the light incident-surface side. The second lens 122 is formed of a double-concave lens. The second afocal optical system 120 adjusts the luminous flux diameter of the blue light E. The blue light E adjusted in luminous flux diameter by the second afocal optical system 120 is incident on the dichroic mirror 80.

The dichroic mirror 80 is disposed on the optical path from the second afocal optical system 120 to the pickup optical system 130. The dichroic mirror 80 reflects the blue light E and transmits yellow fluorescent light Y including red light and green light.

The pickup optical system 130 has the function of causing the blue light E from the dichroic mirror 80 to be incident on a phosphor layer 52 of the rotating fluorescent plate 50 in the state where the blue light E is substantially concentrated, and the function of substantially collimating the fluorescent light Y emitted from the rotating fluorescent plate 50. The pickup optical system 130 includes a first lens 131 and a second lens 132. The first lens 131 and the second lens 132 each include a convex lens.

The rotating fluorescent plate 50 includes a motor 55, a circular plate 51 rotated by the motor 55, the phosphor layer 52 provided in a ring shape on the circular plate 51, and a reflection film 53 provided between the phosphor layer 52 and the circular plate 51. The circular plate 51 is formed of, for example, a member made of metal having an excellent heat dissipation property, such as aluminum or copper.

The phosphor layer 52 contains phosphor particles that absorb the blue light E, converts the blue light E to the yellow fluorescent light Y, and emits the yellow fluorescent light Y. As the phosphor particle, for example, a yttrium-aluminum-garnet (YAG) based phosphor can be used. The forming material of phosphor particles may be of one kind, or a mixture of particles formed using two or more kinds of forming materials may be used as phosphor particles.

The first lens array 140 includes a plurality of first small lenses 142 for dividing light from the dichroic mirror 80 into a plurality of partial luminous fluxes. The plurality of first small lenses 142 are arranged in a matrix in a plane orthogonal to an illumination optical axis.

The second lens array 150 includes a plurality of second small lenses 152 corresponding to the plurality of first small lenses 142 of the first lens array 140. The second lens array 150 forms, in conjunction with the superimposing lens 170, images of the first small lenses 142 of the first lens array 140 in the vicinities of the image forming regions of the liquid crystal light modulators 400R, 400G, and 400B. The plurality of second small lenses 152 are arranged in a matrix in a plane orthogonal to the illumination optical axis.

The polarization conversion element 160 converts each of the partial luminous fluxes divided by the first lens array 140 to linearly polarized light. The polarization conversion element 160 includes a polarization separation layer, a reflection layer, and a retardation film. The polarization separation layer transmits one of linearly polarized components of polarization components that are included in the light from the rotating fluorescent plate 50 as it is, and reflects the other linearly polarized component in a direction perpendicular to the illumination optical axis. The reflection layer reflects the other linearly polarized component reflected by the polarization separation layer in a direction parallel to the illumination optical axis. The retardation film converts the other linearly polarized component reflected by the reflection layer to the one linearly polarized component.

The superimposing lens 170 concentrates the partial luminous fluxes from the polarization conversion element 160 and superimposes the partial luminous fluxes on each other in the vicinities of the image forming regions of the liquid crystal light modulators 400R, 400G, and 400B. The first lens array 140, the second lens array 150, and the superimposing lens 170 constitute an integrator optical system that makes an in-plane light intensity distribution of the light from the rotating fluorescent plate 50 uniform. In the embodiment, the superimposing lens 170 corresponds to “second condensing optical system” in the appended claims.

FIG. 2 is a ray diagram in a main portion of the illumination device 100. Specifically, FIG. 2 shows a ray diagram of the blue light B emitted from the first collimating optical system 15. In FIG. 2, the reflection mirror 35 and the dichroic mirror 80 are omitted for clarity of illustration.

In the embodiment, the rays B1 transmitted through the first afocal optical system 20 are incident in the state of being parallel to each other on the diffusing element 30 as shown in FIG. 2. That is, the rays B1 are incident in regions different from each other on the diffusing element 30. The first afocal optical system 20 is configured such that the rays B1 are incident in the regions different from each other on the diffusing element 30. Specifically, the first afocal optical system 20 causes the plurality of rays B1 incident thereon in the state of being parallel to each other to be emitted in the state of being parallel to each other.

The ray B1 diffused by the diffusing element 30 is incident in a spread state on the pickup optical system 40. The diffusing element 30 is provided at the focal position of the pickup optical system 40. Specifically, a light-exiting surface 30a of the diffusing element 30 is provided at the focal position (on the focal plane) of the pickup optical system 40. Therefore, the rays B1 diffused by the diffusing element 30 are converted to parallel lights by passing through the pickup optical system 40, and are superimposed at a predetermined position S. In the embodiment, the predetermined position S corresponds to a position where the first lens array 140 is disposed.

According to the embodiment, in the case where the plurality of rays B1 diffused by the diffusing element 30 are superimposed on the first lens array 140, even if, for example, one ray B1 is not emitted because of any abnormality occurring in the first light source device 10, the illuminance distribution formed on the first lens array 140 is less affected. That is, the illumination device 100 can reduce color unevenness occurring in the image forming regions of the liquid crystal light modulators 400R, 400B, and 400G.

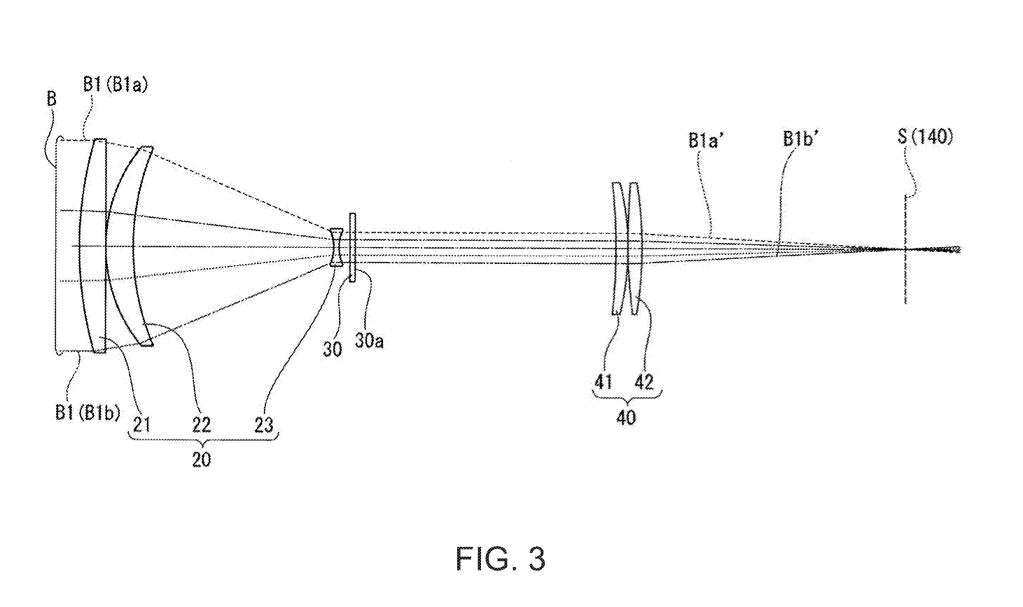

FIG. 3 shows principal rays of the rays B1. One ray B1 of the plurality of rays B1 is referred to as “ray B1a”, and another ray B1 is referred to as “ray B1b”. In FIG. 3, principal rays of the ray B1a and the ray B1b are respectively denoted by reference signs B1a′ and B1b′. In the embodiment, the ray B1a corresponds to “first light beam” in the appended claims, and the ray B1b corresponds to “second light beam” in the appended claims.

As shown in FIG. 3, the principal ray B1a′ and the principal ray B1b′ are refracted by the pickup optical system 40 and travel so as to come close to each other toward the first lens array 140. Then, the principal ray B1a′ and the principal ray B1b′ are concentrated at one point at the position where the first lens array 140 is disposed. As shown in FIG. 3, principal rays other than the principal ray B1a′ and the principal ray B1b′ also travel so as to come close to each other toward the first lens array 140, and are concentrated at one point at the predetermined position S (the disposing position of the first lens array 140).

In the embodiment, the rays B1 are incident in the regions different from each other on the diffusing element 30. Therefore, a spot size that is formed on the diffusing element 30 is larger than a spot size that is formed on the diffusing element 30 in the related art in which the rays B1 are incident in the same region on the diffusing element 30. Therefore, the diffusion angle of the diffusing element 30 of the embodiment can be made smaller than the diffusion angle of the diffusing element in the related art.

While the spot size formed on the diffusing element 30 is large in the embodiment, etendue, which is defined by the product of the emission area and the divergence solid angle, does not so increase because the diffusion angle is made small. With this configuration, light is not blocked by the polarization conversion element 160, and therefore, the blue light B can be efficiently used.

By the way, a pickup optical system that picks up light diffused at a large angle has a very short focal length. The pickup optical system having a short focal length requires three lenses because of the necessity of lens power, and one of the lenses is an aspheric lens. Therefore, when a diffusing element with a large diffusion angle is used, the cost of the pickup optical system increases.

In contrast, when the diffusion angle due to the diffusing element 30 is made small as in the embodiment, the focal length of the pickup optical system 40 can be extended. The lens power can be lowered with the extended focal length, and therefore, the number of lenses can be reduced. Since the pickup optical system 40 of the embodiment includes the lenses 41 and 42 including two plano-convex lenses each including a spherical surface as described above, a reduction in cost is achieved.

Moreover, it is generally known that the divergence angle of light emitted from a semiconductor laser has anisotropy. Therefore, when the rays B1 of the blue light B emitted from the first light source device 10 are incident on the diffusing element 30, there is a difference in the range of incident angle between the Y-direction and the X-direction.

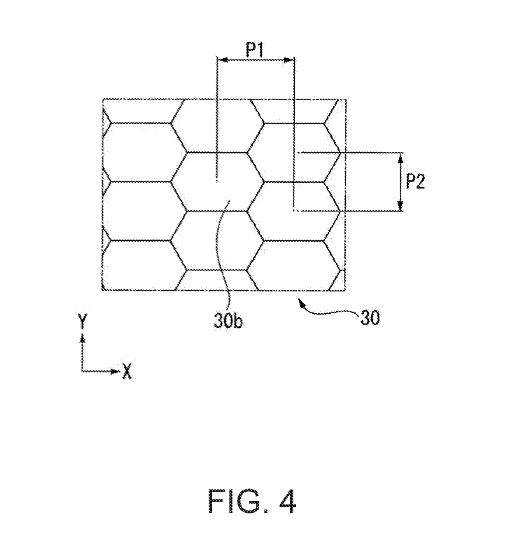

FIG. 4 is a diagram showing a configuration of a main portion of the diffusing element 30 of the embodiment. A direction in which the divergence angle of the ray B1 is small is the X-direction, while a direction in which the divergence angle of the ray B1 is large is the Y-direction.

As shown in FIG. 4, the diffusing element 30 of the embodiment is formed of a lens array including a plurality of microlenses 30b whose planar shapes are hexagonal. In the diffusing element 30, a pitch P1 of the microlenses 30b, which are arranged in a hexagonal array, in the X-direction is larger than a pitch P2 in the Y-direction.

Based on this configuration, the diffusing element 30 can diffuse the ray B1 relatively largely in the X-direction in which the divergence angle is small, and can diffuse the ray B1 relatively small in the Y-direction in which the divergence angle is large. With this configuration, the diffusion angle of the ray B1 diffused by the diffusing element 30 in the X-direction is substantially equal to the diffusion angle in the Y-direction. Therefore, the region of the first lens array 140 irradiated with the blue light B has substantially the same size in the X-direction and the Y-direction. That is, the aspect ratio is substantially 1.

Although the planar shape of the microlens 30b of the embodiment is hexagonal, the planar shape or arrangement is not limited to this. The planar shape may be quadrilateral. The arrangement may be random.

As described above, since the illumination device 100 of the embodiment includes the diffusing element 30, speckle can be reduced. Further, since the diffusion angle of the diffusing element 30 is relatively small, backscattering due to the diffusing element 30 is reduced. Moreover, since the diffusion angle due to the diffusing element 30 is relatively small, a light component having a large incident angle with respect to the pickup optical system 40 is less. With this configuration, reflection on the light-incident surface of the first pickup lens 41 can be reduced.

Hence, since the loss due to the backscattering at the diffusing element 30 and the reflection on the light-incident surface of the first pickup lens 41 are reduced, the blue light B emitted from the first light source device 10 can be efficiently used.

Moreover, since the spot size of the blue light B formed on the diffusing element 30 is increased, a sufficient speckle-reducing effect is obtained even when the diffusion angle of the diffusing element 30 is relatively small.

### Second Embodiment

Subsequently, a projector according to a second embodiment will be described. Configurations and members common to the above embodiment are denoted by the same reference numerals and signs, and the detailed description thereof is omitted.

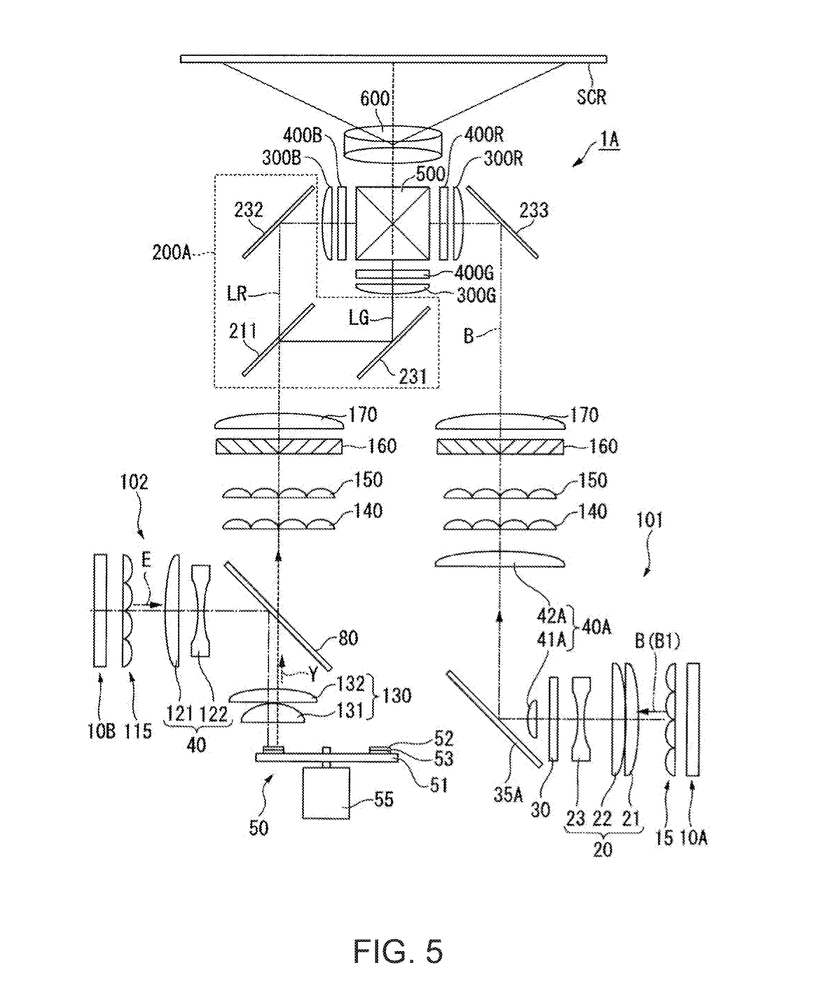

FIG. 5 is a top view showing an optical system of the projector according to the embodiment.

As shown in FIG. 5, the projector 1A of the embodiment includes a first illumination device 101, a second illumination device 102, a color separation and light guide optical system 200A, the liquid crystal light modulators 400R, 400G, and 400B, the cross dichroic prism 500, and the projection optical system 600. In the embodiment, the first illumination device 101 corresponds to “illumination device” stated in the appended claims.

In the embodiment, the first illumination device 101 emits the blue light B toward the color separation and light guide optical system 200A, and the second illumination device 102 emits the yellow fluorescent light Y including red light and green light toward the color separation and light guide optical system 200A.

The color separation and light guide optical system 200A includes a dichroic mirror 211 and reflection mirrors 231 and 232. The color separation and light guide optical system 200A separates the yellow light from the second illumination device 102 into the red light and the green light, and guides the red light and the green light to the respectively corresponding liquid crystal light modulators 400R and 400G.

The dichroic mirror 211 is a dichroic mirror that transmits a red light component and reflects a green light component.

The reflection mirror 231 is a reflection mirror that reflects the green light component, and the reflection mirror 232 is a reflection mirror that reflects the red light component.

The green light LG reflected by the dichroic mirror 211 is further reflected by the reflection mirror 231, passes through the field lens 300G, and is incident on the image forming region of the liquid crystal light modulator 400G for green light.

The red light LR transmitted through the dichroic mirror 211 is reflected by the reflection mirror 232, passes through the field lens 300R, and is incident on the image forming region of the liquid crystal light modulator 400R for red light.

The blue light B emitted from the first illumination device 101 is reflected by a reflection mirror 233, passes through the field lens 300B, and is incident on the image forming region of the liquid crystal light modulator 400B for blue light.

The first illumination device 101 includes a light source device 10A, the first collimating optical system 15, the first afocal optical system 20, the diffusing element 30, a reflection mirror 35A, a pickup optical system 40A, the first lens array 140, the second lens array 150, the polarization conversion element 160, and the superimposing lens 170.

The light source device 10A has the same configuration as the first light source device 10 of the first embodiment. Therefore, the blue light B emitted from the light source device 10A includes a bundle of rays including the plurality of rays B1.

The pickup optical system 40A includes a first pickup lens 41A and a second pickup lens 42A.

Each of the first pickup lens 41A and the second pickup lens 42A is formed of a plano-convex lens including a spherical surface on the light exiting-surface side. In the embodiment, the reflection mirror 35A is disposed between the first pickup lens 41A and the second pickup lens 42A.

The second illumination device 102 includes a light source device 10B, the second afocal optical system 120, the dichroic mirror 80, the pickup optical system 130, the rotating fluorescent plate 50, the first lens array 140, the second lens array 150, the polarization conversion element 160, and the superimposing lens 170.

The light source device 10B has the same configuration as the second light source device 110 of the first embodiment. Therefore, the blue light E emitted from the light source device 10B includes a bundle of rays including a plurality of rays.

In the second illumination device 102, the superimposing lens 170 concentrates the partial luminous fluxes from the polarization conversion element 160 and superimposes the partial luminous fluxes on each other in the vicinities of the image forming regions of the liquid crystal light modulators 400R and 400G.

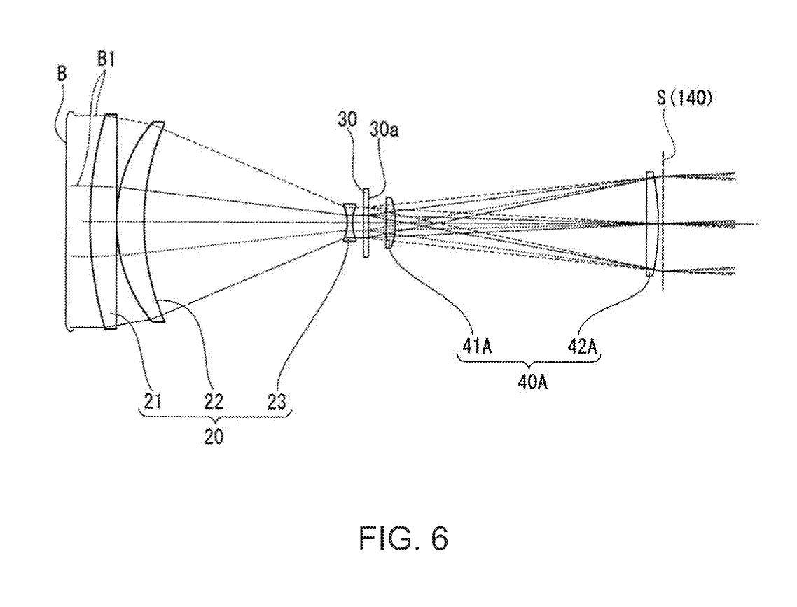

FIG. 6 is a ray diagram in a main portion of the first illumination device 101. Specifically, FIG. 6 shows a ray diagram of the blue light B emitted from the first collimating optical system 15. In FIG. 6, the reflection mirror 35A is omitted for clarity of illustration.

As shown in FIG. 6, the ray B1 diffused by the diffusing element 30 is incident in a spread state on the pickup optical system 40A.

The diffusing element 30 is provided at the focal position of the pickup optical system 40A. Specifically, the light-exiting surface 30a of the diffusing element 30 is provided at the focal position (on the focal plane) of the pickup optical system 40A. Therefore, the rays B1 diffused by the diffusing element 30 are converted to parallel lights by passing through the pickup optical system 40A (the second pickup lens 42A), and are superimposed on the first lens array 140 disposed at the predetermined position S.

In the embodiment, the first pickup lens 41A and the second pickup lens 42A, which constitute the pickup optical system 40A, are disposed in the state of being spaced apart from each other. Specifically, the first pickup lens 41A is disposed in the vicinity of the diffusing element 30 as compared with the first embodiment.

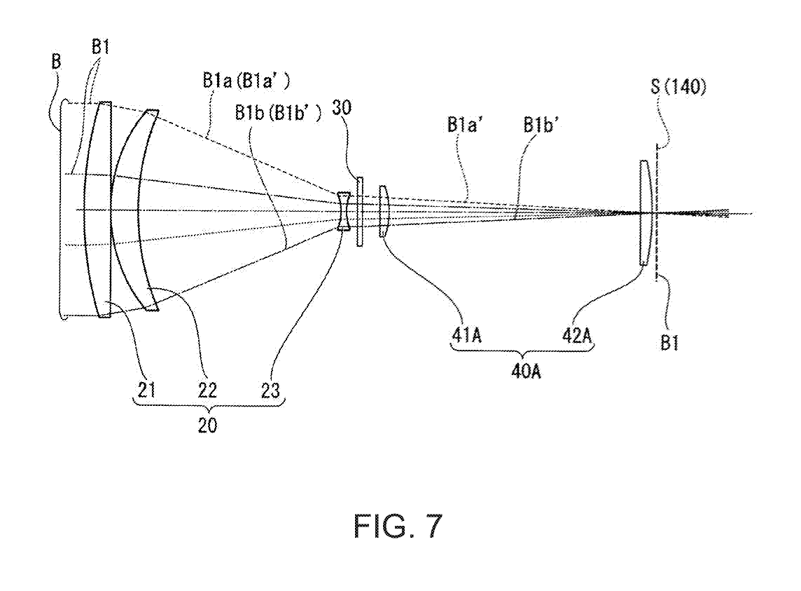

FIG. 7 represents only principal rays of the rays B1 with respect to FIG. 6. One ray B1 of the plurality of rays B1 is referred to as “ray B1a, and another ray B1 is referred to as “ray B1b”. In FIG. 7, principal rays of the ray B1a and the ray B1b are respectively denoted by reference signs B1a′ and B1b′.

The principal ray B1a′ and the principal ray B1b′ are refracted by the first pickup lens 41A and travel so as to come close to each other toward the first lens array 140. Then, the principal ray B1a′ and the principal ray B1b′ are concentrated at one point at the position where the first lens array 140 is disposed.

The principal ray B1a′ and the principal ray B1b′ begin to come close to each other immediately after passing through the first pickup lens 41A, and therefore are concentrated at one point in the vicinity of the rear side of the second pickup lens 42A disposed spaced apart from the first pickup lens 41A. As shown in FIG. 7, principal rays other than the principal ray B1a′ and the principal ray B1b′ also travel so as to come close to each other toward the first lens array 140, and are concentrated at one point in the vicinity of the rear side of the second pickup lens 42A as described above.

Here, when the first lens array 140 is disposed at the concentration position of the principal ray of the ray B1, the spread of the illuminance distribution on the first lens array 140 can be suppressed.

According to the embodiment, the blue light B emitted from the first illumination device 101 can be efficiently used similarly to the first embodiment.

Moreover, according to the embodiment, the first lens array 140 can be disposed in the vicinity of the rear side of the second pickup lens 42A. That is, the first illumination device 101 can be downsized as compared with the configuration of the first embodiment. That is, the projector 1A itself, which includes the first illumination device 101, is also downsized.

### Modified Example of Second Embodiment

Subsequently, a modified example of the second embodiment will be described. Specifically, the modified example differs from the second embodiment in that principal rays of the blue light B emitted from a first afocal optical system 20A are incident so as to be concentrated on the diffusing element 30.

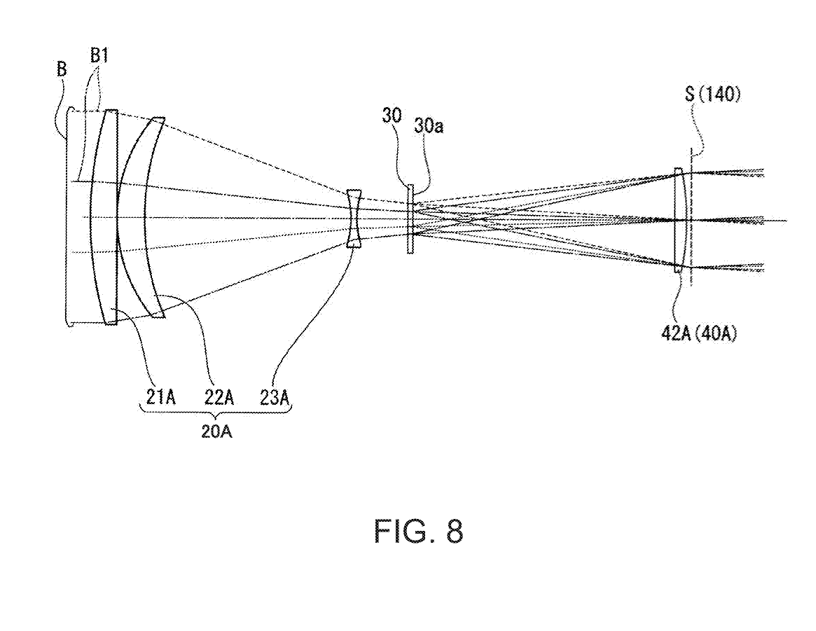

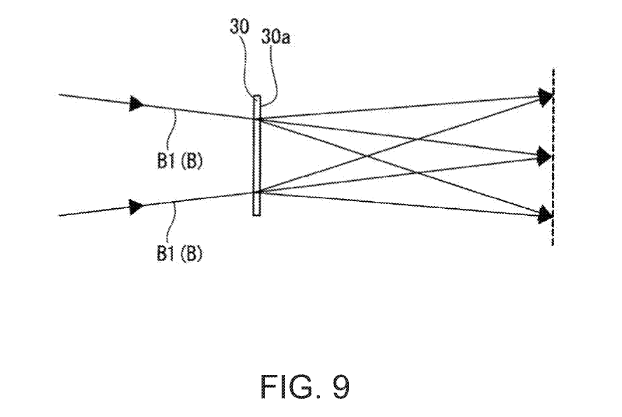

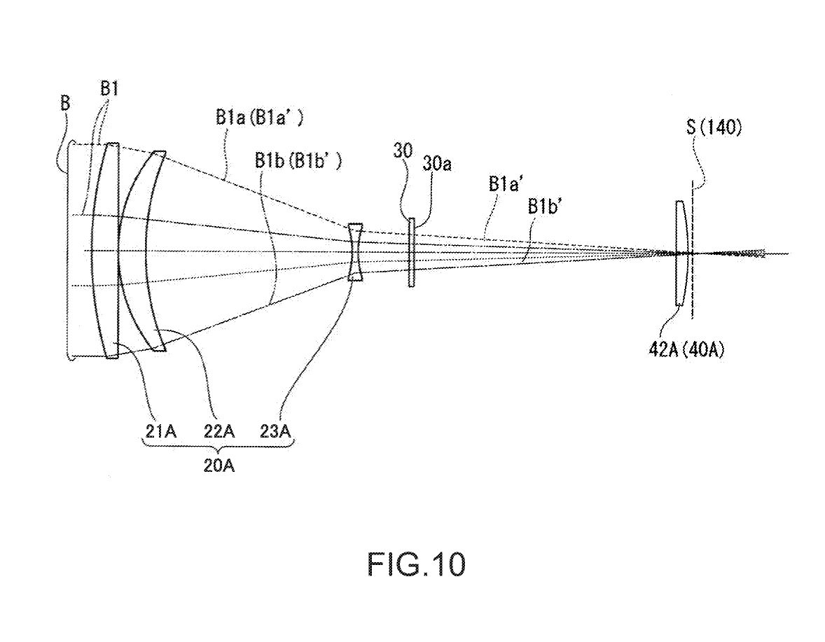

FIG. 8 is a ray diagram of the blue light B in the modified example. FIG. 9 is an enlarged view showing a main portion of the blue light B emitted from the diffusing element 30. FIG. 10 shows principal rays of the rays B1. One ray B1 of the plurality of rays B1 is referred to as “ray B1a”, and another ray B1 is referred to as “ray B1b”. In FIG. 10, principal rays of the ray B1a and the ray B1b are respectively denoted by reference signs B1a′ and B1b′. FIG. 8 corresponds to FIG. 6 of the second embodiment, and FIG. 10 corresponds to FIG. 7 of the second embodiment.

As shown in FIG. 8, the first afocal optical system 20A includes a first lens 21A, a second lens 22A, and a third lens 23A. The first afocal optical system 20A is configured so as to cause the plurality of rays B1 incident thereon in the state of being parallel to each other to be emitted in the state of being concentrated together. Therefore, the principal ray B1a′ and the principal ray B1b′ are incident so as to be concentrated on the diffusing element 30 as shown in FIG. 10, and also after being emitted from the diffusing element 30, the principal ray B1a′ and the principal ray B1b′ travel so as to come close to each other toward the first lens array 140. This is substantially equivalent to the ray diagram of the blue light B after passing through the first pickup lens 41A in the second embodiment. That is, in the modified example, the blue light B is incident from the first afocal optical system 20A on the diffusing element 30 in the state where the blue light B is slightly concentrated; therefore, the first pickup lens 41A of the second embodiment is omitted. The degree of concentration of the blue light B through the first afocal optical system 20A is designed based on the concentration position of the principal ray B1a′ and the principal ray B1b′ through the second pickup lens 42A.

According to the modified example, since the first pickup lens 41A can be removed from the components of the pickup optical system 40A of the second embodiment, the cost can be reduced.

### Third Embodiment

Subsequently, a projector according to a third embodiment will be described. Configurations and members common to the above embodiments are denoted by the same reference numerals and signs, and the detailed description thereof is omitted.

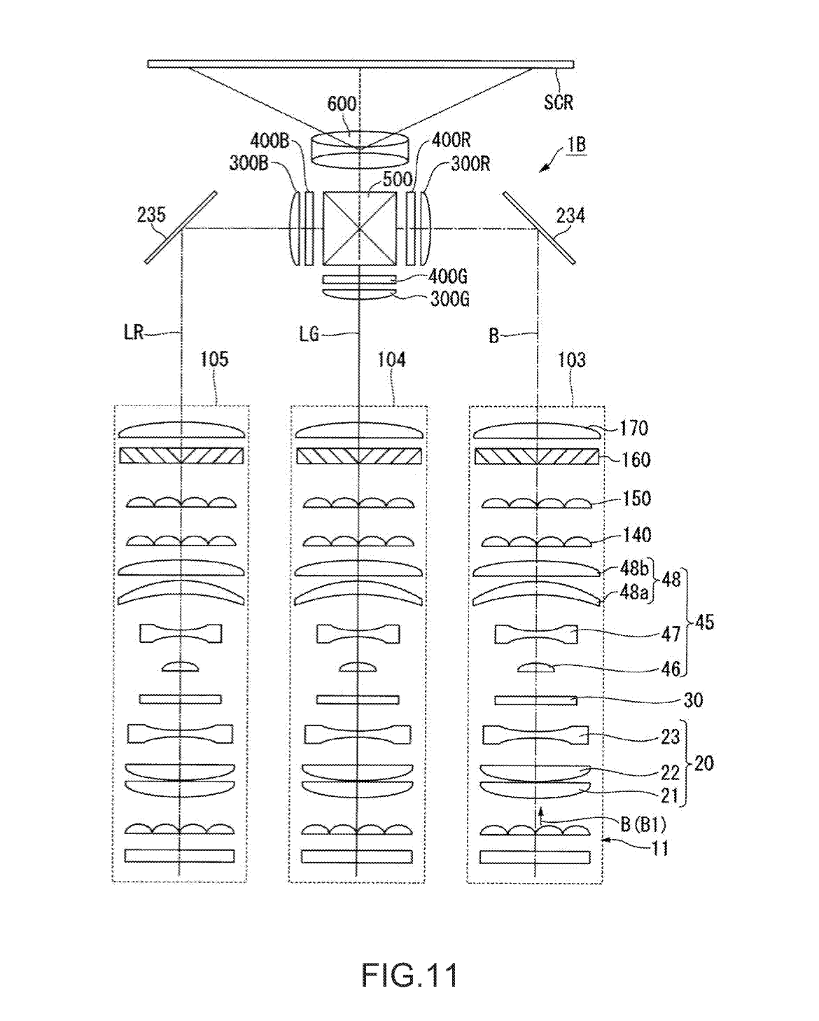

FIG. 11 is a top view showing an optical system of the projector according to the embodiment.

As shown in FIG. 11, the projector 1B of the embodiment includes a red illumination device 105, a green illumination device 104, a blue illumination device 103, reflection mirrors 234 and 235, the liquid crystal light modulators 400R, 400G, and 400B, the cross dichroic prism 500, and the projection optical system 600. In the embodiment, each of the red illumination device 105, the green illumination device 104, and the blue illumination device 103 corresponds to “illumination device” stated in the appended claims.

In the embodiment, the red illumination device 105 emits the red light LR, the green illumination device 104 emits the green light LG, and the blue illumination device 103 emits the blue light B.

The red light LR emitted from the red illumination device 105 is reflected by the reflection mirror 235, passes through the field lens 300R, and is incident on the image forming region of the liquid crystal light modulator 400R for red light.

The green light LG emitted from the green illumination device 104 directly passes through the field lens 300G and is incident on the image forming region of the liquid crystal light modulator 400G for green light.

The blue light B emitted from the blue illumination device 103 is reflected by the reflection mirror 234, passes through the field lens 300B, and is incident on the image forming region of the liquid crystal light modulator 400B for blue light.

The red illumination device 105, the green illumination device 104, and the blue illumination device 103 have the same configuration except that they emit lights of different colors. Hereinafter, only the configuration of the blue illumination device 103 will be described.

The blue illumination device 103 includes a light source device 11, the first collimating optical system 15, the first afocal optical system 20, the diffusing element 30, a pickup optical system 45, the first lens array 140, the second lens array 150, the polarization conversion element 160, and the superimposing lens 170.

The light source device 11 has the same configuration as the first light source device 10 of the first embodiment. Therefore, the blue light B emitted from the light source device 11 includes a bundle of rays including the plurality of rays B1. In the red illumination device 105, the red light LR is emitted from a light source device 11. In the green illumination device 104, the green light LG is emitted from a light source device 11.

In the embodiment, the pickup optical system 45 includes a first lens group 46, a second lens group 47, and a third lens group 48, which are disposed in this order from the diffusing element 30 side. The first lens group 46 has a positive power; the second lens group 47 has a negative power; and the third lens group 48 has a positive power. In the embodiment, the first lens group 46 corresponds to “first lens group” in the appended claims; the second lens group 47 corresponds to “second lens group” in the appended claims; and the third lens group 48 corresponds to “third lens group” in the appended claims.

In the embodiment, the first lens group 46 is formed of one plano-convex lens (spherical surface lens). The second lens group 47 is formed of one double-concave lens. The third lens group 48 is formed of a meniscus lens 48a and a plano-convex lens 48b. The first lens group 46 and the second lens group 47 may be each formed of a plurality of lenses.

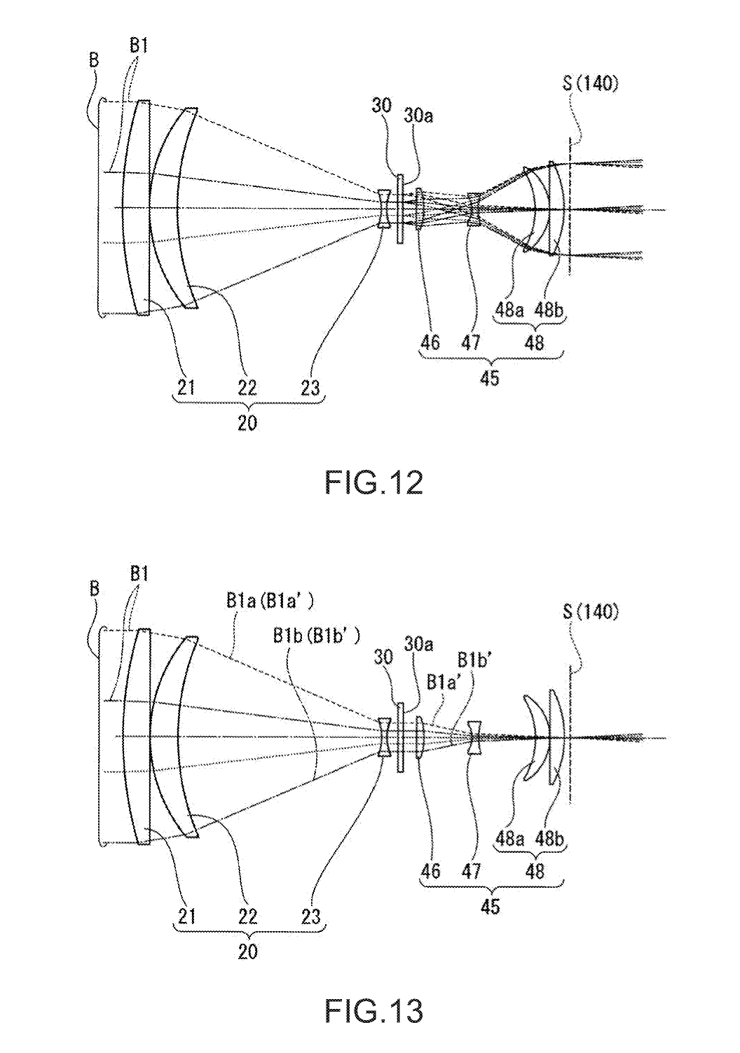

FIG. 12 is a ray diagram in a main portion of the blue illumination device 103. Specifically, FIG. 12 shows a ray diagram of the blue light B emitted from the first collimating optical system 15.

As shown in FIG. 12, the ray B1 diffused by the diffusing element 30 is incident in a spread state on the pickup optical system 45.

The diffusing element 30 is provided at the focal position of the pickup optical system 45. Specifically, the light-exiting surface 30a of the diffusing element 30 is provided at the focal position (on the focal plane) of the pickup optical system 45. Therefore, the rays B1 diffused by the diffusing element 30 are converted to parallel lights by passing through the pickup optical system 45, and are superimposed on the first lens array 140 disposed at the predetermined position S.

FIG. 13 is a diagram showing principal rays of the rays B1. One ray B1 of the plurality of rays B1 is referred to as “ray B1a”, and another ray B1 is referred to as “ray B1b”. In FIG. 13, principal rays of the ray B1a and the ray B1b are respectively denoted by reference signs B1a′ and B1b.

In the embodiment, the principal ray B1a′ of the ray B1a and the principal ray B1b′ of the ray B1b travel so as to come close to each other toward the first lens array 140.

Specifically, the principal ray B1a′ and the principal ray B1b′, which are transmitted through the diffusing element 30 in the state where the principal ray B1a′ and the principal ray B1b′ are parallel to each other, are refracted by the first lens group 46 and incident so as to come close (so as to be concentrated) to each other on the second lens group 47 as shown in FIG. 13. After the degree of concentration is reduced by refraction through the second lens group 47, the principal ray B1a′ and the principal ray B1b′ pass through the third lens group 48 and are concentrated at the predetermined position S. Principal rays other than the principal ray B1a′ and the principal ray B1b′ also travel similarly and are concentrated at the predetermined position S.

Here, when the first lens array 140 is disposed at the concentration position of the principal ray of the ray B1, the spread of the illuminance distribution on the first lens array 140 can be suppressed.

According to the embodiment as described above, the red light LR, the green light LG, and the blue light B respectively emitted from the red illumination device 105, the green illumination device 104, and the blue illumination device 103 can be efficiently used.

Moreover, according to the embodiment, the illumination device can be downsized as compared with the first embodiment and the second embodiment.

Hence, the projector 1B including the red illumination device 105, the green illumination device 104, and the blue illumination device 103 is also downsized.

### Modified Example of Third Embodiment

Subsequently, a modified example of the third embodiment will be described. Specifically, the modified example differs from the third embodiment in that principal rays of light emitted from the first afocal optical system 20A are incident so as to be concentrated on the diffusing element 30.

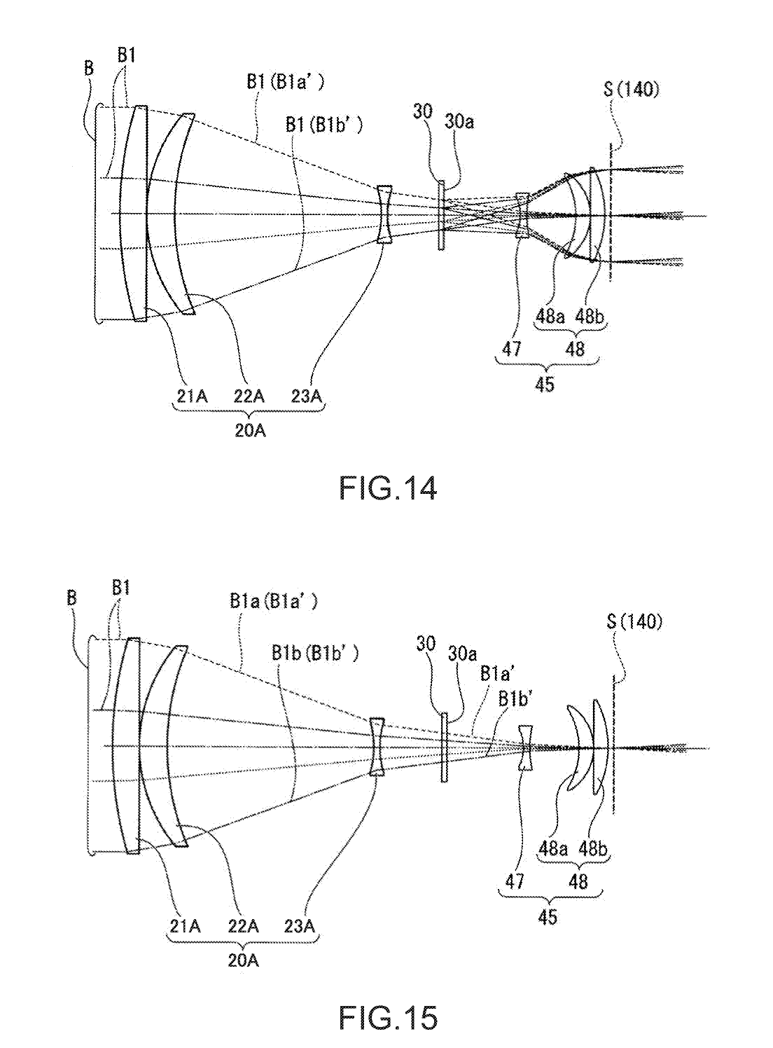

FIG. 14 is a ray diagram of the blue light B in the modified example. FIG. 15 shows principal rays of the rays B1. One ray B1 of the plurality of rays B1 is referred to as “ray B1a”, and another ray B1 is referred to as “ray B1b”. In FIG. 15, principal rays of the ray B1a and the ray B1b are respectively denoted by reference signs B1a′ and B1b′. FIG. 14 corresponds to FIG. 12 of the third embodiment, and FIG. 15 corresponds to FIG. 13 of the third embodiment.

As shown in FIG. 15, the principal ray B1a′ and the principal ray B1b′ are incident so as to be concentrated on the diffusing element 30, and also after being emitted from the diffusing element 30, the principal ray B1a′ and the principal ray B1b′ travel so as to come close to each other toward the first lens array 140. This is substantially equivalent to the ray diagram of the blue light B after passing through the first lens group 46 in the third embodiment. That is, in the modified example, the blue light B is incident from the first afocal optical system 20A on the diffusing element 30 in the state where the blue light B is slightly concentrated; therefore, the first lens group 46 of the third embodiment is omitted. The degree of concentration of the blue light B through the first afocal optical system 20A is designed based on the concentration position of the principal ray B1a′ and the principal ray B1b′ through the pickup optical system 45 formed of the second lens group 47 and the third lens group 48.

According to the modified example, since the first lens group 46 can be removed from the components of the pickup optical system 45 of the third embodiment, the cost can be reduced.

### Fourth Embodiment

Subsequently, a projector according to a fourth embodiment will be described. Configurations and members common to the above embodiments are denoted by the same reference numerals and signs, and the detailed description thereof is omitted.

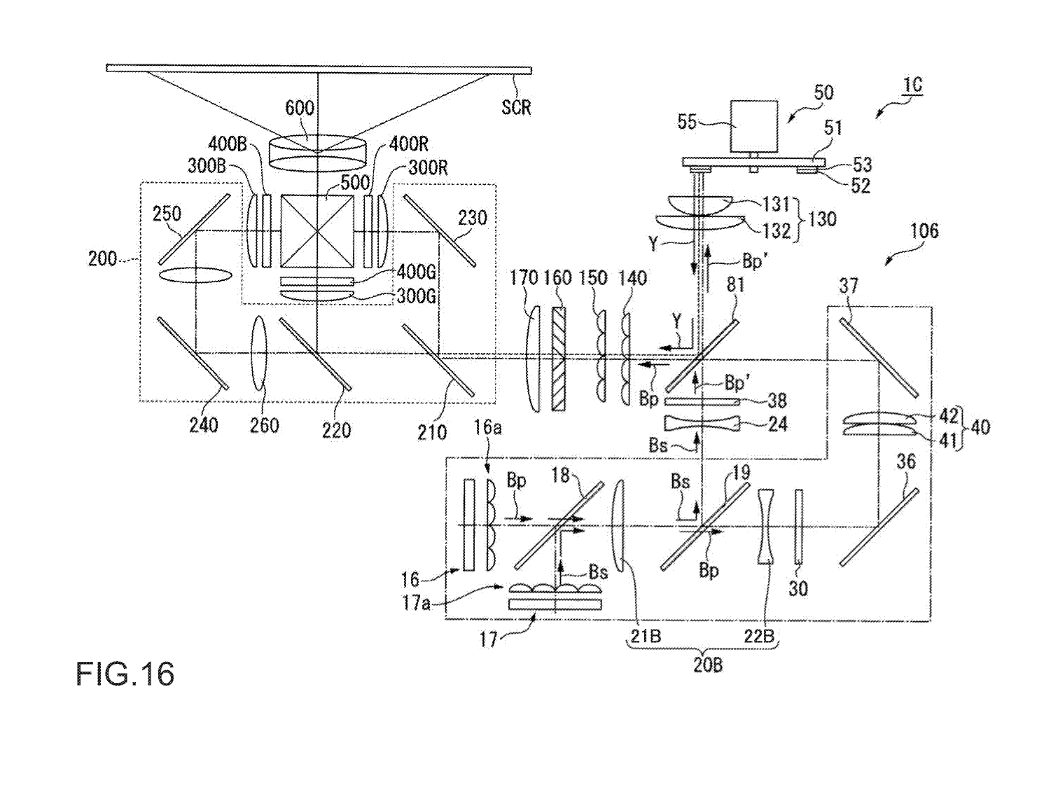

FIG. 16 is a top view showing an optical system of the projector according to the embodiment.

As shown in FIG. 16, the projector 1C of the embodiment includes an illumination device 106, the color separation and light guide optical system 200, the liquid crystal light modulators 400R, 400G, and 400B, the cross dichroic prism 500, and the projection optical system 600.

In the embodiment, the illumination device 106 emits white light toward the color separation and light guide optical system 200.

The illumination device 106 includes a first light source device 16, a first collimating optical system 16a, a second light source device 17, a second collimating optical system 17a, a first polarization separation element 18, a second polarization separation element 19, a first afocal optical system 20B, a fourth lens 24, a retardation film 38, the diffusing element 30, the pickup optical system 40, a reflection mirror 36, a reflection mirror 37, a third polarization separation element 81, the pickup optical system 130, the rotating fluorescent plate 50, the first lens array 140, the second lens array 150, the polarization conversion element 160, and the superimposing lens 170.

The first light source device 16 emits blue light Bp including a plurality of laser lights similarly to the above embodiments. The second light source device 17 emits blue light Bs including a plurality of laser lights. In the embodiment, the blue light Bp emitted from the first light source device 16 is incident as P-polarized light on the first polarization separation element 18, the second polarization separation element 19, and the third polarization separation element 81. The blue light Bs emitted from the second light source device 17 is incident as S-polarized light on the first polarization separation element 18 and the second polarization separation element 19.

The second polarization separation element 19 is located between a first lens 21B and a second lens 22B that constitute the first afocal optical system 20B. The reflection mirror 36 is located between the diffusing element 30 and the pickup optical system 40.

The first polarization separation element 18, the second polarization separation element 19, and the third polarization separation element 81 are each formed of, for example, a dichroic mirror. These elements reflect an S-polarization component of incident light and transmit a P-polarization component of the incident light. The third polarization separation element 81 has a color separation function of reflecting fluorescent light, to be described later, in a wavelength band different from that of the blue light, irrespective of the polarization state.

In the embodiment, the blue light Bp emitted from the first light source device 16 passes through the first polarization separation element 18, the second polarization separation element 19, and the first afocal optical system 20B and is incident on the diffusing element 30. The first afocal optical system 20B is configured so as to cause the plurality of rays B1 incident thereon in the state of being parallel to each other to be emitted in the state of being parallel to each other. The ray B1 diffused by the diffusing element 30 is incident in a spread state on the pickup optical system 40. The plurality of rays B1 transmitted through the pickup optical system 40 are reflected by the reflection mirror 37, pass through the third polarization separation element 81, and then are superimposed on each other on the first lens array 140.

In the embodiment, a ray diagram of the blue light Bp passing through the first afocal optical system 20B, the diffusing element 30, the pickup optical system 40, and the first lens array 140 is equivalent to FIGS. 2 and 3 of the first embodiment.

On the other hand, the blue light Bs emitted from the second light source device 17 is reflected by the first polarization separation element 18 and the second polarization separation element 19 and incident on the fourth lens 24. In the embodiment, the fourth lens 24 is formed of a double-concave lens. The fourth lens 24 constitutes, in conjunction with the first lens 21B, an afocal optical system.

The blue light Bs transmitted through the fourth lens 24 is incident on the retardation film 38. The retardation film 38 is, for example, a λ/2-plate. The retardation film 38 emits the blue light Bs incident as S-polarized light thereon, as blue light Bp′ of P-polarized light.

The blue light Bp′ passes through the third polarization separation element 81 and is incident on the pickup optical system 130. The pickup optical system 130 has the function of causing the blue light Bp′ from the third polarization separation element 81 to be incident on the phosphor layer 52 of the rotating fluorescent plate 50 in the state where the blue light Bp′ is substantially concentrated, and the function of substantially collimating the fluorescent light Y emitted from the rotating fluorescent plate 50.

The fluorescent light Y emitted from the phosphor layer 52 is reflected by the third polarization separation element 81 and combined with the blue light Bp transmitted through the third polarization separation element 81. With this configuration, the white light is produced.

According to the embodiment, since the loss due to the backscattering at the diffusing element 30 and the reflection on the light-incident surface of the first pickup lens 41 are reduced similarly to the first embodiment, the blue light Bp emitted from the first light source device 16 is efficiently used.

Moreover, when the optical path length of the blue light Bp needs to be lengthened, a pickup optical system 40 having a relatively long focal length may be used.

The invention is not limited to the details of the above embodiments, and can be appropriately modified within the scope not departing from the gist of the invention.

For example, the diffusing element 30 has been described as being provided at the focal position of the pickup optical system in the above embodiments; however, the diffusing element 30 may be disposed at a position slightly deviated from the focal position of the pickup optical system. That is, it is sufficient that the diffusing element 30 is provided in the vicinity of the focal position of the pickup optical system.

When the diffusing element 30 is disposed at the position deviated from the focal position of the pickup optical system, a plurality of secondary light source images formed on the second lens array 150 are blurred and thus a speckle-reducing effect can be enhanced. The amount of deviation from the focal position may be set within the range where the secondary light source image remains on the second small lens 152 of the second lens array 150.

Moreover, an example in which the first lens array 140 is disposed at the predetermined position S where the light diffused by the diffusing element 30 is concentrated has been described in the above embodiments; however, the position where the first lens array 140 is disposed may be close to the pickup optical system side. In this case, in consideration of blur occurring in the illuminance distribution on the first lens array 140, the diffusion angle of the diffusing element 30 may be set small.

Moreover, an example in which the illumination device according to the invention is mounted in the projector including the liquid crystal light modulators has been shown in the above embodiments; however, the invention is not limited to this example. As a light modulator, for example, a digital micromirror device may be used. Moreover, the illumination device according to the invention can also be applied to a luminaire, an automobile headlight, or the like.

The entire disclosure of Japanese Patent Application No. 2016-030219, filed on Feb. 19, 2016 is expressly incorporated by reference herein.

What is claimed is:

1. An illumination device comprising:
a light source device that emits a bundle of rays including a first light beam and a second light beam;
a collimating optical system on which the bundle of rays is incident;
a diffusing element on which the bundle of rays transmitted through the collimating optical system is incident;
a first collecting optical system on which the bundle of rays diffused by the diffusing element is incident;
a first lens array on which the bundle of rays transmitted through the first collecting optical system is incident;
a second lens array provided at the rear stage of the first lens array; and
a second condensing optical system provided at the rear stage of the second lens array, wherein
the first light beam and the second light beam are incident on regions different from each other on the diffusing element,
a principal ray of the first light beam and a principal ray of the second light beam travel so as to come close to each other toward the first lens array, and
the diffusing element is provided in the vicinity of a focal position of the first collecting optical system.

2. The illumination device according to claim 1, wherein
the principal ray of the first light beam and the principal ray of the second light beam are incident in the state of being parallel to each other on the diffusing element.

3. The illumination device according to claim 2, wherein
the first collecting optical system includes, in order from the diffusing element side, a first lens group having a positive power, a second lens group having a negative power, and a third lens group having a positive power.

4. The illumination device according to claim 1, wherein
the principal ray of the first light beam and the principal ray of the second light beam are incident so as to be concentrated on the diffusing element.

5. A projector comprising:
the illumination device according to claim 1;
a light modulator that modulates, in response to image information, light from the illumination device to thereby form image light; and
a projection optical system that projects the image light.

6. A projector comprising:
the illumination device according to claim 2;
a light modulator that modulates, in response to image information, light from the illumination device to thereby form image light; and
a projection optical system that projects the image light.

7. A projector comprising:
the illumination device according to claim 3;
a light modulator that modulates, in response to image information, light from the illumination device to thereby form image light; and
a projection optical system that projects the image light.

8. A projector comprising:
the illumination device according to claim 4;
a light modulator that modulates, in response to image information, light from the illumination device to thereby form image light; and
a projection optical system that projects the image light.
